(19) United States
(12) Patent Application Publication
(10) Pub. No.: US 2015/0284989 A1
(43) Pub. Date: Oct. 8, 2015

(54) DISPLAY DEVICE WITH DOOR

(71) Applicant: SAMSUNG DISPLAY CO., LTD., Yongin-city (KR)

(72) Inventors: Ka-In KIM, Goyang-si (KR); Eun-Jin Kim, Ulsan (KR); Seung-Mi BAEK, Suwon-si (KR)

(21) Appl. No.: 14/473,979

(22) Filed: Aug. 29, 2014

(30) Foreign Application Priority Data
Apr. 8, 2014 (KR) 10-2014-0041723

(51) Int. Cl. E06B 7/28

(52) U.S. Cl. CPC E06B 7/28

(57) ABSTRACT

A door with a display unit mounted therein. This display unit has: a first substrate; a driving circuit on the first substrate; a display device on the driving circuit; a second substrate on the display device; and a door knob on the first substrate and the second substrate. The display unit is configured to display at least one of an individual identification code, a current state of usage, current user information, a duration of use, next user information, and current time information of a predetermined space.

### CROSS-REFERENCE TO RELATED APPLICATION

This application claims priority to, and the benefit of, Korean Patent Application No. 10-2014-0041723, filed on Apr. 8, 2014 with the Korean Intellectual Property Office, the disclosure of which is incorporated herein in its entirety by reference.

### BACKGROUND

1. Field

The present disclosure relates generally to flat panel displays. More specifically, the present disclosure relates to a display device with a door designed to easily obtain information about inner space usage from the outside.

2. Description of Related Art

Various types of display devices have been developed for recent use. As one example, transparent display devices are capable of maintaining visual transparency when displaying text or images. In general, transparent display devices are manufactured by forming transparent electronic devices made by transparent materials upon a transparent substrate. These transparent display devices may be utilized for multiple purposes in various environments. For example, transparent display devices may be applied on windows of houses and stores or vehicle windshields so as to provide users with desired information or for advertising purposes.

It is to be understood that this Background section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

The present disclosure is directed to a door with a display device mounted within, where the display device is programmed to display information regarding the room behind the door. In this manner, passersby can easily determine information regarding what is currently going on in the room or rooms behind the door.

According to an embodiment of the present invention, a door comprises a door having a display unit mounted therein, the display unit comprising: a first substrate; a driving circuit on the first substrate; a display device on the driving circuit; a second substrate on the display device; and a door knob on the first substrate and the second substrate. The display unit is configured to display at least one of an individual identification code, a current state of usage, current user information, a duration of use, next user information, and current time information of a predetermined space.

The current state of usage of the predetermined space can be displayed in a predetermined color.

The current state of usage of the predetermined space can be displayed in transparent or opaque manner depending on the state of usage of the predetermined space.

The display unit may be further configured to display a memo input by a user.

The display unit may be further configured with at least one of a writing recognition mode for input of the memo by a writing from the user, or a voice recognition mode for input of the memo by spoken words from the user.

The door may further include a touch screen panel disposed on at least one substrate of the first substrate and the second substrate.

The first substrate and the second substrate may include one of glass, tempered glass, and a transparent plastic.

The transparent plastic may include at least one selected from a group consisting of kapton, polyethersulphone (PES), polycarbonate (PC), polyimide (PI), polyethyleneterephthalate (PET), polyethylenenaphthalate (PEN), polyacrylate (PAR), and fiber reinforced plastic (FRP).

The driving circuit may include a thin film transistor layer.

The thin film transistor layer may include an oxide semiconductor.

The thin film transistor layer may include a transparent electrode material.

The transparent electrode material may include transparent conductive oxide (TCO).

The transparent conductive oxide may include at least one selected from a group consisting of indium tin oxide (ITO), indium zinc oxide (IZO), antimony tin oxide (ATO), aluminum zinc oxide (AZO), zinc oxide (ZnO), and an alloy thereof.

The display device may include an organic light emitting device.

According to embodiments of the present invention, a display device within a door is capable of providing information about usage of the space behind the door, so as to make information regarding the space readily available to viewers on the outside.

The foregoing is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present disclosure of invention will be more clearly understood from the following detailed description taken in conjunction with the accompanying drawings, in which:

FIG. 1 is a plan view showing a door having a display device according to an embodiment of the present invention;

FIG. 2 is a partial plan view enlarging section “A” of FIG. 1;

FIG. 3 is a cross-sectional view taken along a line I-I′ of FIG. 2;

FIGS. 4 through 6 are schematic diagrams for explaining exemplary applications of a display device according to an embodiment of the present invention.

The various figures are not to scale.

### DETAILED DESCRIPTION

Hereinafter, embodiments of the present disclosure of invention will be described in more detail with reference to the accompanying drawings.

Although the present invention can be modified in various manners and have several embodiments, specific embodiments are illustrated in the accompanying drawings and will be mainly described in the specification. However, the scope of the embodiments of the present invention is not limited to the specific embodiments and should be construed as including all the changes, equivalents, and substitutions included in the spirit and scope of the present invention.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” can be termed likewise without departing from the teachings herein.

Some of the parts which are not associated with the description may not be provided in order to specifically describe embodiments of the present invention, and like reference numerals refer to like elements throughout the specification.

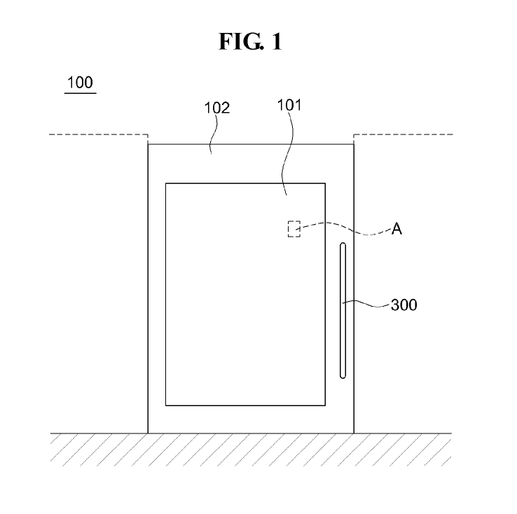

Referring to FIG. 1, according to an embodiment of the present invention, the display device 100 may be divided into a display unit 101 displaying an image, and a non-display unit 102 at the edge of, and in this case surrounding an outer edge of, the display unit 101.

The display unit 101 may include a plurality of pixels, and an image is displayed using the pixels. The non-display unit 102 may include various wirings (not illustrated) for supplying driving signals to the respective pixels, and a door knob 300 for opening and closing the display device 100.

According to an embodiment of the present invention, the display device 100 may include a door which opens and closes in a sliding manner. Further, any generally used types of door knobs may be used as the door knob 300. The display device 100 is itself a door that slides open and shut, and contains a display unit 101 within it. The display unit 101 can show nearby people information such as information regarding the room behind the door. In this manner, for example, the door/display device 100 can be the door to a lecture hall, and can be programmed to display the lecture, or display information such as time, whether a lecture is currently ongoing, or the like.

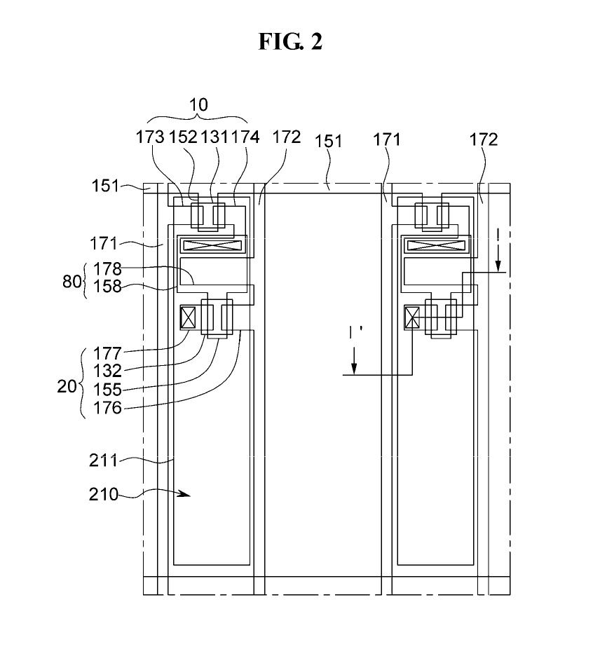

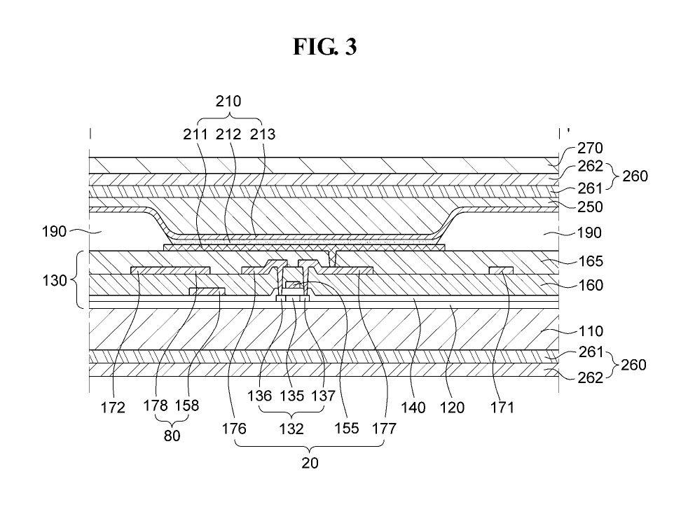

FIG. 2 is a partial plan view enlarging section “A” of FIG. 1 and FIG. 3 is a cross-sectional view taken along a line I-I′ of FIG. 2.

Referring to FIGS. 2 and 3, according to an embodiment of the present invention, the display device 100 includes a first substrate 110, a driving circuit 130 on the first substrate 110, a display device 210 on the driving circuit 130, and a second substrate 250 on the display device 210.

In addition, a coating layer 260 may be disposed on one side of one or both of the first substrate 110 and the second substrate 250. The coating layer 260 may include at least one of a water-resistant coating layer and a heat-resistant coating layer.

Further, a touch screen panel 270 may be disposed on the coating layer 260.

The display device 210 may be one of an organic light emitting diode (OLED), a liquid crystal display (LCD), and an electrophoretic display (EPD). These display devices can include one or more thin film transistors (TFTs). Hereinafter, for purposes of example it is assumed that the display device 210 includes an OLED.

The driving circuit 130 is disposed on the first substrate 110 so as to drive the display device 210. The driving circuit 130 includes a switching TFT 10, a driving TFT 20, and a capacitor 80, and drives a display device 210 such as an OLED.

A detailed configuration of the driving circuit 130 and the OLED 210 are described in FIGS. 2 and 3; however, embodiments of the present invention are not limited thereto. Thus, the driving circuit 130 and the OLED 210 may have many different configurations which are known to and can be carried out by those skilled in the pertinent art.

Referring to FIG. 2, a pixel is depicted as including two TFTs and a capacitor; however embodiments of the present invention are not limited thereto, and may have any other configuration and combination of TFTs, capacitors, and other elements. Thus, for example, one pixel may include three or more TFTs and two or more capacitors, and may have various configurations including additional wirings. Herein, the pixel refers conceptually to the smallest display unit displaying a portion of an image.

Referring to FIGS. 2 and 3, a pixel includes a switching TFT 10, a driving TFT 20, a capacitor 80, and an OLED 210. Herein, the driving circuit 130 refers to a configuration including the switching TFT 10, the driving TFT 20, and the capacitor 80.

The driving circuit 130 includes a gate line 151 disposed generally along one direction, a data line 171 insulated from and intersecting the gate line 151, and a common power line 172. In general, one pixel may be defined or outlined by the gate line 151, the data line 171, and the common power line 172; however, the pixel is not limited to the aforementioned embodiment. The boundaries of the pixel may also be defined by a black matrix or a pixel defining layer.

The first substrate 110 and the second substrate 250 may be made of any transparent material or combination of materials. For example, the substrates 110, 250 may include glasses, tempered glasses, and plastics that are transparent. For example, transparent plastics may include at least one material selected from a group consisting of kapton, polyethersulphone (PES), polycarbonate (PC), polyimide (PI), polyethyleneterephthalate (PET), polyethylenenaphthalate (PEN), polyacrylate (PAR), and fiber reinforced plastic (FRP).

A buffer layer 120 is disposed on the first substrate 110. The buffer layer 120 is configured to planarize a surface and/or to prevent penetration of impurities, and may be formed of various materials capable of serving these roles. For example, the buffer layer 120 may be made of one of a SiNx layer, a SiO₂ layer, and a SiOxNy layer. However, the buffer layer 120 is not always necessary, and may be omitted depending on the type of the substrate 110 and process conditions employed.

A switching semiconductor layer 131 and a driving semiconductor layer 132 are disposed on the buffer layer 120. The switching semiconductor layer 131 and the driving semiconductor layer 132 may be made of one of a polycrystalline silicon layer, an amorphous silicon layer, and oxide semiconductors such as indium-gallium-zinc oxide (IGZO) and indium zinc tin oxide (IZTO). For example, in a case where the driving semiconductor layer 132 illustrated in FIG. 3 is formed of a polycrystalline silicon layer, the driving semiconductor layer 132 includes a channel region 135 which is not doped with impurities, and a source region 136 and a drain region 137 formed at each side of the channel region 135 by p+ doping. In this case, the doped ion material is a p-type impurity such as such as that including boron B, and B₂H₆ is often used. These impurities vary depending on the type of TFTs used. According to an embodiment of the present invention, a TFT having a PMOS structure doped with p-type impurities is used as the TFT 20; however, the driving TFT 20 is not limited thereto. Thus, a TFT having an NMOS structure or a CMOS structure may alternatively be used as the driving TFT 20.

A gate insulating layer 140 is disposed on the switching semiconductor layer 131 and the driving semiconductor layer 132. The gate insulating layer 140 may include at least one of tetraethylorthosilicate (TEOS), silicon nitride (SiNx), and silicon oxide (SiO₂). For example, the gate insulating layer 140 may have a double-layer structure where a silicon nitride layer having a thickness of 40 nm and a TEOS layer having a thickness of 80 nm are sequentially laminated.

A gate line 151 including gate electrodes 152 and 155 is disposed on the gate insulating layer 140. The gate line 151 also includes a first capacitor plate 158, and other wirings. The gate electrodes 152 and 155 are disposed to overlap at least a part of the semiconductor layers 131 and 132, and more particularly the channel regions thereof. The gate electrodes 152 and 155 are configured to prevent impurity doping on the respective channel regions when the source region 136 and the drain region 137 of the semiconductor layers 131 and 132 are doped with impurities.

The gate electrodes 152 and 155 are disposed on the same layer as the first capacitor plate 158, and made of substantially the same metal. The gate electrodes 152 and 155 and the first capacitor plate 158 may include at least one of molybdenum (Mo), chromium (Cr), and tungsten (W).

The interlayer insulating layer 160 covers the gate electrodes 152 and 155 is disposed on the gate insulating layer 140. The interlayer insulating layer 160 may be formed of silicon nitride (SiNx), silicon oxide (SiO₂), TEOS or the like, however, embodiments of the present invention are not limited thereto.

The data line 171 includes the source electrodes 173 and 176 and the drain electrodes 174 and 177, and is disposed on the interlayer insulating layer 160. The data line 171 also includes the common power line 172, a second capacitor plate 178, and other wirings.

Further, the source electrodes 173 and 176 and the drain electrodes 174 and 177 are connected to the source region 136 and the drain region 137 of the semiconductor layers 131 and 132 through contact holes formed on the gate insulating layer 140 and the interlayer insulating layer 160.

As described above, the switching TFT 10 includes the switching semiconductor layer 131, the switching gate electrode 152, the switching source electrode 173, and the switching drain electrode 174. The driving TFT 20 includes the driving semiconductor layer 132, the driving gate electrode 155, the driving source electrode 176, and the driving drain electrode 177. However, the configuration of the TFTs 10 and 20 is not limited to the above-described embodiment, and may have many different configurations which are known to and can be carried out by those skilled in the pertinent art.

In addition, the capacitor 80 includes the first capacitor plate 158 and the second capacitor plate 178 facing each other with the interlayer insulating layer 160 interposed therebetween.

The switching TFT 10 is used as a switching element configured to select pixels for emitting light. The switching gate electrode 152 is connected to the gate line 151. The switching source electrode 173 is connected to the data line 171. The switching drain electrode 174 is spaced apart from the switching source electrode 173 and is connected to the first capacitor plate 158.

The driving TFT 20 applies driving power to the pixel electrode 211, so that the emitting layer 212 of the OLED 210 in the selected pixel emits light. The driving gate electrode 155 is connected to the first capacitor plate 158. The driving source electrode 176 and the second capacitor plate 178 are each connected to the common power line 172. The driving drain electrode 177 is connected to the pixel electrode 211 of the OLED 210 through a contact hole.

With the above-described structure, the switching TFT 10 is driven by a gate voltage applied to the gate line 151 to transmit a data voltage from the data line 171 to the driving TFT 20. A voltage equivalent to a difference between a common voltage applied from the common power line 172 to the driving TFT 20 and the data voltage applied from the switching TFT 10 is applied to the capacitor 80, and a corresponding current from the capacitor 80 flows to the OLED 210 via the driving TFT 20, such that the OLED 210 emits light.

A planarizing layer 165 is disposed to cover data lines patterned at the same layer, such as the data line 171, the common power line 172, the source electrodes 173 and 176, and the drain electrodes 174 and 177 disposed on the interlayer insulating layer 160.

The planarizing layer 165 is configured to eliminate or reduce steps and to planarize a surface so as to improve efficiency. The planarizing layer 180 can be made of at least one of polyacrylates resin, epoxy resin, phenolic resin, polyamides resin, polyimides resin, unsaturated polyesters resin, polyphenylenethers resin, polyphenylenesulfides resin, and benzocyclobutene (BCB).

A pixel electrode 211 of the OLED 210 is disposed on the planarizing layer 165. The pixel electrode 211 is connected to the drain electrode 177 through a contact hole formed in the planarizing layer 165.

At least a part of the pixel electrode 211 is exposed above the planarizing layer 165, and a pixel defining layer 190 defining a pixel area is disposed thereon. The pixel electrode 211 is disposed to correspond to the pixel area defined by the pixel defining layer 190. The pixel defining layer 190 may be made of resins such as polyacrylates resin and polyimides resin.

The light emitting layer 212 is disposed on the pixel electrode 211 in the pixel area, and the common electrode 213 is disposed on the pixel defining layer 190 and the light emitting layer 212. The light emitting layer 212 is made of a low molecular weight organic material or a polymer organic material. At least one of a hole injection layer HTL or a hole transporting layer HTL may be further disposed between the pixel electrode 211 and the light emitting layer 212, and at least one of an electron transporting layer (ETL) and an electron Injection Layer (EIL) may be further disposed between the light emitting layer 212 and the common electrode 213.

The pixel electrode 211 and the common electrode 213 may be formed as any one of the following: a transmissive electrode, a semi-transmissive electrode, and a reflective electrode.

A transmissive electrode may be made of a transparent conductive oxide (TCO). The transparent conductive oxide TCO may be selected from a group consisting of indium tin oxide (ITO), indium zinc oxide (IZO), antimony tin oxide (ATO), aluminum zinc oxide (AZO), zinc oxide (ZnO), and alloys thereof.

A semi-transmissive or a reflective electrode may be made of a metal such as magnesium (Mg), silver (Ag), gold (Au), calcium (Ca), lithium (Li), chromium (Cr), aluminum (Al), and copper (Cu), or an alloy thereof. In this case, whether an electrode is a semi-transmissive type or a reflective type depends on the thickness of the electrode. Generally, the semi-transmissive electrode has a thickness of about 200 nm or less, and the reflective electrode has a thickness of about 300 nm or more. As the thickness of the semi-transmissive electrode decreases, the transmittance of light and the resistance become higher. On the contrary, as the thickness of the semi-transmissive electrode increases, the transmittance of light decreases.

Further, the semi-transmissive and reflective electrodes may have a multilayer structure including a metal layer made of metal or metal alloys, and a transparent conductive oxide layer laminated on the metal layer.

According to an embodiment of the present invention, the display device 100 has a structure where light is emitted from both sides. That is, the light emitting layer 212 emits light through both the pixel electrode 211 and the common electrode 213. Therefore, both of the first electrode 211 and the second electrode 213 may be formed as a transmissive type or a semi-transmissive type electrode.

The second substrate 250 is spaced apart from the second electrode 213. A transparent insulating substrate made of glasses, plastics with a transparent material, and the like may be used as the second substrate 250. Further, the second substrate 250 may have a thin film encapsulation structure where one or more inorganic layers and one or more organic layers are alternately laminated.

A coating layer 260 may be disposed on one side of each of the first substrate 110 and the second substrate 250. The coating layer 260 may include at least one of water-resistant coating layer 261 and heat-resistant coating layer 262. The coating layer 260 may prevent water or heat from the outside environment from penetrating the device 100, so as to prevent damage to the display device 100.

The water-resistant coating layer 261 may use transparent polymer materials. For example, the water-resistant coating layer 261 may use polyester and parylene. The water-resistant layer 261 may be coated by a thermal diffusion deposition method or bonded in a film form at room temperature. Any water-resistant coating material generally used by those skilled in the art may be applied to the embodiment of the present invention.

The heat-resistant coating layer 262 is also transparent, and may use a material having high thermal conductivity. For example, the heat-resistant coating layer 262 may use a graphite sheet, acryl sheet, and the like. Any heat-resistant coating material generally used by those skilled in the art may be applied to the embodiment of the present invention.

Further, a touch screen panel 270 may be disposed on the coating layer 260. A user may select a mode or input text by using the touch screen panel 270, in known manner.

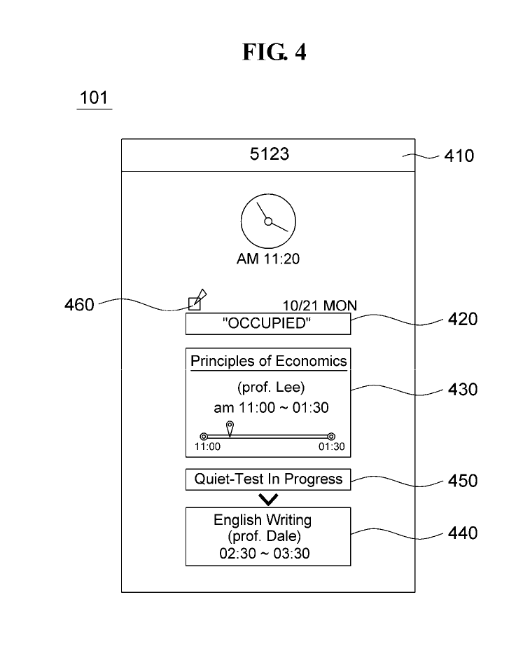

FIGS. 4 through 6 are schematic diagrams for explaining application examples of a display device according to an embodiment of the present invention.

The display unit 101 of the display device 100 may display individual identification code, current state of usage, current user information, duration of use, next user information, and current time information.

Hereinafter, a case where the display device 100 according to an embodiment of the present invention is installed in a school lecture room will be described as an illustrative and nonlimiting example. Here, the door 100 displays information regarding the lecture room behind the door 100.

Referring to FIG. 4, the display unit 101 of the display device 100 may display a lecture room number 410, current state of usage 420, current lecture information 430, next lecture information 440, and the like.

The current state of usage 420 may be displayed in a predetermined color. For example, the current state of usage 420 may be displayed in red in a case where the lecture is ongoing, and may be displayed in green in a case where there is not any ongoing lecture. The current state of usage 420 may also be displayed in other predetermined colors as well.

In addition, or alternatively, the current state of usage 420 may be displayed opaquely in a case where the lecture is ongoing, and may be displayed transparently in a case where there is not any ongoing lecture.

Accordingly, a predetermined color and/or transparency level is displayed depending on whether the lecture room is in use or not, such that outside users can easily recognize the state of usage of the lecture room.

The lecture information 430 may include items such as the name of the lecture, name of the professor, lecture time, and the like. As illustrated in FIG. 4, the lecture time visually displays elapsed time and remaining time compared to the current time, and therefore can be intuitively recognized by outside users.

In addition, a memo 450 inputted by a user may be displayed by using the input unit 460 on the display unit 101 of the display device 100.

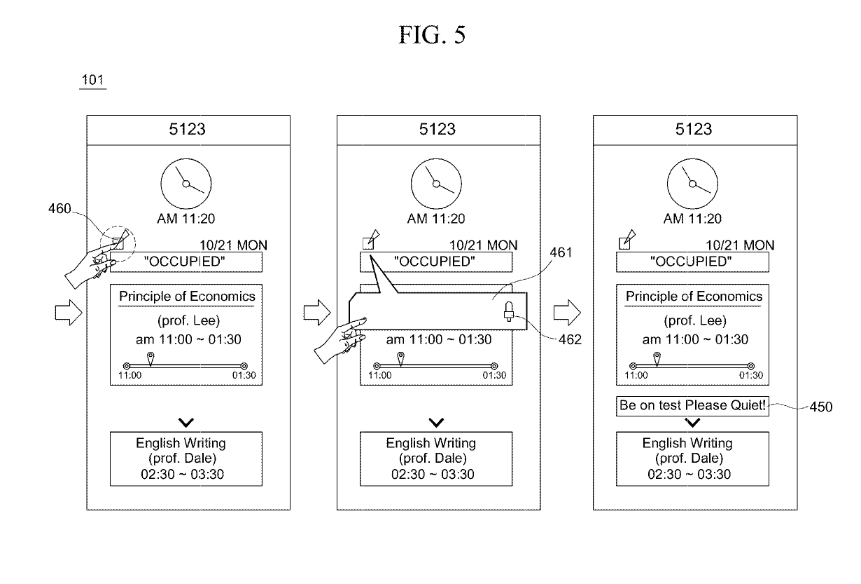

Referring to FIG. 5, in a case where a user touches the input unit 460, a pop-up window 461 on which the user can input memos or notices can be displayed. The user may input memos or notices by using a finger or a stylus pen in the pop-up window 461, or by typing on a pop-up keyboard (not shown). Further, the user may input memos or notices by selecting a voice recognition mode 462.

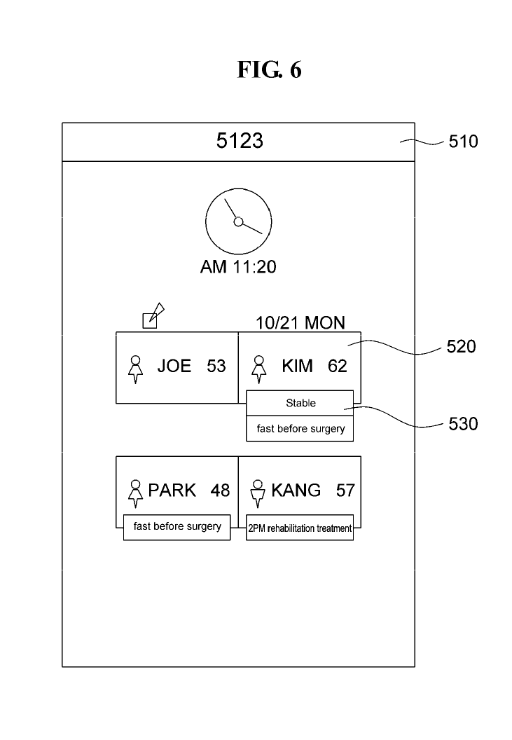

FIG. 6 illustrates a case where the display device 100 according to an embodiment of the present invention is installed, for example, in a hospital patient room, so that the door 100 displays information regarding the patient(s) in the room behind the door 100.

Referring to FIG. 6, the display unit 101 of the display device 100 may display a patient room number 510, patient private information 520, patient state information 530, and the like.

The patient private information 520 may display name, gender, age, hospitalization period, and the like.

The patient state information 530 may display the current state of the patient and scheduled treatment information, and the like, and may be displayed in a predetermined color depending on the state of the patient. For example, the patient state information 530 may be displayed in red in a case where the patient is in critical condition, and may be displayed in green in a case where the patient is not in critical condition. The patient state information 530 may also be displayed in other predetermined colors as well.

Accordingly, a predetermined color or transparency level is displayed depending on the state of the patient, such that outside users can recognize the state of the patient intuitively.

From the foregoing, it will be appreciated that various embodiments in accordance with the present disclosure have been described herein for purposes of illustration, and that various modifications may be made without departing from the scope and spirit of the present teachings. For example, any one or more features of one or more embodiments may be mixed and matched in any combinations, so as to produce further embodiments of the invention. Accordingly, the various embodiments disclosed herein are not intended to be limiting of the true scope and spirit of the present teachings.

What is claimed is:

1. A door comprising:
a door having a display unit mounted therein, the display unit comprising:
a first substrate;
a driving circuit on the first substrate;
a display device on the driving circuit;
a second substrate on the display device; and
a door knob on the first substrate and the second substrate,
wherein the display unit is configured to display at least one of an individual identification code, a current state of usage, current user information, a duration of use, next user information, and current time information of a predetermined space.

2. The door of claim 1, wherein the current state of usage of the predetermined space is configured to be displayed in a predetermined color.

3. The door of claim 1, wherein the current state of usage of the predetermined space is configured to be displayed in transparent or opaque manner depending on the state of usage of the predetermined space.

4. The door of claim 1, wherein the display unit is further configured to display a memo input by a user.

5. The door of claim 4, wherein the display unit is further configured with at least one of a writing recognition mode for input of the memo by a writing from the user, or a voice recognition mode for input of the memo by spoken words from the user.

6. The door of claim 1, further comprising a touch screen panel disposed on at least one substrate of the first substrate and the second substrate.

7. The door of claim 1, wherein the first substrate and the second substrate comprise one of glass, tempered glass, and transparent plastic.

8. The door of claim 7, wherein the transparent plastic comprises at least one selected from a group consisting of kapton, polyethersulphone (PES), polycarbonate (PC), polyimide (PI), polyethyleneterephthalate (PET), polyethylenenaphthalate (PEN), polyacrylate (PAR), and fiber reinforced plastic (FRP).

9. The door of claim 1, wherein the driving circuit comprises a thin film transistor layer.

10. The door of claim 9, wherein the thin film transistor layer comprises an oxide semiconductor.

11. The door of claim 9, wherein the thin film transistor layer comprises a transparent electrode material.

12. The door of claim 11, wherein the transparent electrode material comprises transparent conductive oxide (TCO).

13. The door of claim 12, wherein the transparent conductive oxide comprises at least one selected from a group consisting of indium tin oxide (ITO), indium zinc oxide (IZO), antimony tin oxide (ATO), aluminum zinc oxide (AZO), zinc oxide (ZnO), and an alloy thereof.

14. The door of claim 1, wherein the display device comprises an organic light emitting device.
